(19) United States
(12) Patent Application Publication
(10) Pub. No.: US 2007/0146934 A1
(43) Pub. Date: Jun. 28, 2007

(54) Method and apparatus for a base plate used in a head gimbal assembly of a hard disk drive

(75) Inventors: Momo Boljanovic, Milpitas, CA (US); Michael Sullivan, Fremont, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 11/321,008

(22) Filed: Dec. 28, 2005

(51) Int. Cl. G11B 5/48

(52) U.S. Cl. 360/244.6

(57) ABSTRACT

A method of making a base plate blank by either photo-etching or laser-cutting a blank. The base plate blank includes at least two radial troughs symmetrically arranged about a swage center. The base plate blank is used to make a base plate for a head gimbal assembly by die-stamping the base plate blank, which for at least one of the radial troughs, forms a contact zone away from the radial trough. The die-stamping further includes forming a contact zone away from the radial trough, for each of the radial troughs. The head suspension assembly including the base plate, a head gimbal assembly including the head suspension assembly, an actuator assembly including at least one head gimbal assembly, and a hard disk drive including the actuator assembly, as well as the methods of making the elements of the invention, and those elements as products of these methods.

### TECHNICAL FIELD

This invention relates to hard disk drive components, in particular, to the component of head gimbal assemblies coupling the head gimbal assembly to the actuator arm in the hard disk drive.

### BACKGROUND OF THE INVENTION

Contemporary hard disk drives include an actuator assembly pivoting through an actuator pivot to position one or more read-write heads, embedded in sliders, each over a rotating disk surface. The data stored on the rotating disk surface is typically arranged in concentric tracks. To access the data of a track, a servo controller first positions the read-write head by electrically stimulating the voice coil motor, which couples through the voice coil and an actuator arm to move a head gimbal assembly in positioning the slider close to the track. The focus of this invention is on the mechanical coupling of the actuator arm with the head gimbal assembly.

Currently, ball swaging is the preferred method of attachment of a head gimbal assembly to an actuator arm in a hard disk drive. Swaging is a process for connection where the wall thickness of a thin wall tubular component is expanded against a thick wall component by plastic deformation. The process of swaging involves pressing and fastening the periphery of a boss to the inner face of a through-hole in an actuator arm. The boss is formed in a base plate of the head suspension assembly. The boss is inserted into the through-hole formed in the actuator arm. Then, a ball of a little larger size than the inner diameter of the opening of the boss is passed through. The swaging process generally provides a stronger joint than a press fit, because the thin-wall member is work hardened by the deformation process, which increases tensile strength.

Swaging creates a problem. The base plate tends to buckle from the process. This damages the flatness of the base plate. It also adversely effects the gram change, and torque retention. A cost effective solution is needed for this problem.

### SUMMARY OF THE INVENTION

The invention includes a method of making a base plate by either photo-etching or laser-cutting a blank. The plate blank is a product of this process. The base plate blank includes at least two radial troughs symmetrically arranged about a swage center. This method of making the base plate blank are cost efficient, and readily available for use today.

The base plate blank may further include at least three of the radial troughs. Each of the radial troughs may subtend an angle of at least thirty degrees about the swage center. The thickness of each of the radial troughs is less than the thickness of the blank. The thickness of each of the radial troughs may preferably be zero millimeters. In other words, in some embodiments the trough may extend all the way through the plate creating apertures.

The base plate blank is used to make a base plate for a head gimbal assembly by die-stamping the base plate blank, which for at least one of the radial troughs, forms a contact zone away from the radial trough. The die-stamping may further include forming a contact zone away from the radial trough, for each of the radial troughs. The base plate is a product of this manufacturing process.

In experiments performed using a very expensive manufacturing process for the base plate blank, known as wire EDM, the resulting base plate showed several improvements in tests using the base plate swaged to an actuator arm. Its flatness improved, as well as the gram change and torque retention. However, the wire EDM manufacturing method is far too expensive for use on this part of the hard disk drive.

The invention includes the head suspension assembly including the base plate, a head gimbal assembly including the head suspension assembly, an actuator assembly including at least one head gimbal assembly, and a hard disk drive including the actuator assembly, as well as the methods of making these elements of the invention, and these elements as products of these methods.

### BRIEF DESCRIPTION OF THE DRAWINGS

FIGS. 1A and lB shown the effects of swaging the invention's base plate after swaging to an actuator arm;

FIG. 1C shows a cross section of the base plate blank of FIG. 2A;

FIGS. 2A, 2C, and 2E show the base plate blanks resulting from the invention's method of making them from a blank;

FIGS. 2B, 2D, and 2F show the base plates resulting from die-stamping the corresponding base plate blank of FIG. 2A, 2C and 2E;

FIGS. 3A and 3B show various view of a base plate;

FIG. 4 shows the components of a head suspension assembly and a head gimbal assembly;

FIG. 5 shows the coupling of actuator arms to head gimbal assemblies after the swaging process;

FIGS. 6A to 7 show various aspects of a hard disk drive including the coupled actuators and head gimbal assemblies of FIG. 5; and

FIGS. 8 and 9 show details of the swaging process coupling actuator arms to head gimbal assemblies.

### DETAILED DESCRIPTION

This invention relates to hard disk drive components, in particular, to the component of head gimbal assemblies coupling the head gimbal assembly to the actuator arm.

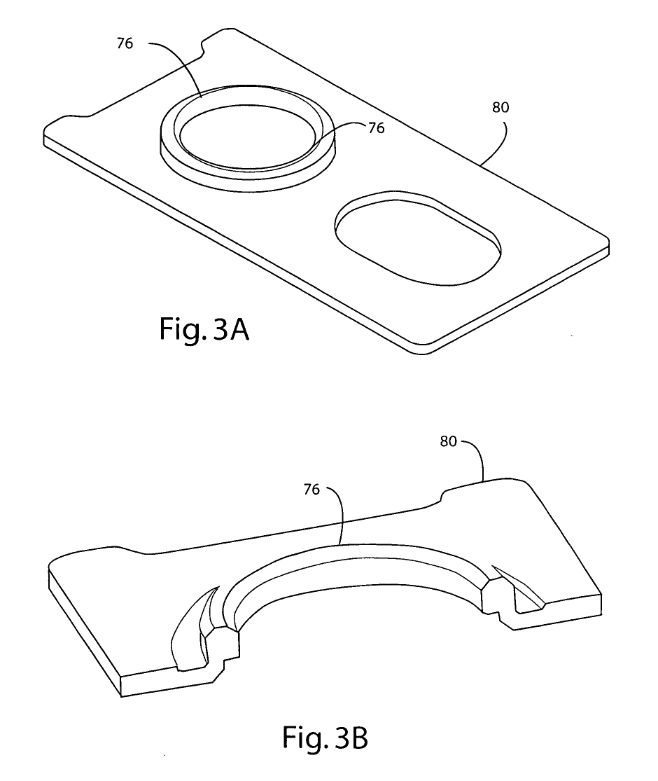

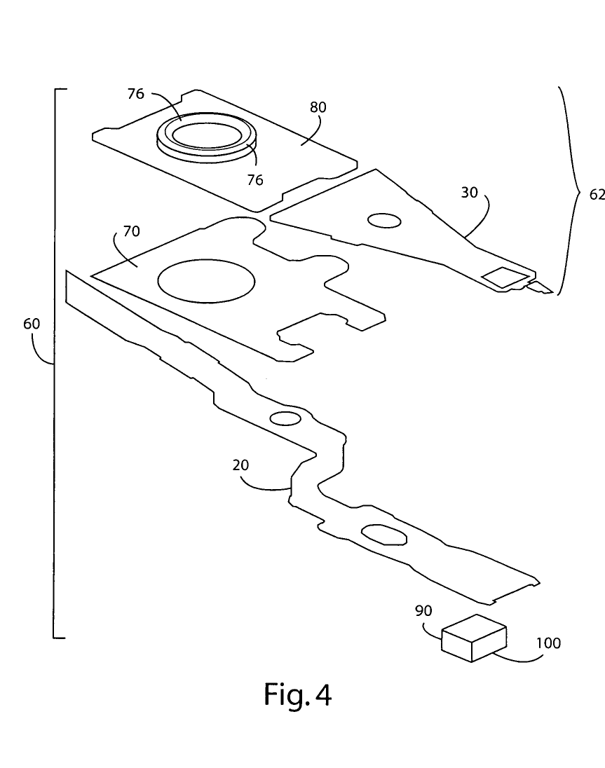

A base plate blank 70, as shown in FIGS. 2A, 2C, and 2E may be made by either photo-etching and/or laser-cutting a blank 2. The blank 2 is typically die-stamped from sheet metal, such as sheet stainless steel, and looks the same as the base plate blank minus the radial troughs 72. The process of making the base plate blank create these radial troughs. The base plate blank is a product of this process. The base plate blank includes at least two radial troughs symmetrically arranged about a swage center 78. The invention's method of making the base plate blank is cost efficient, and readily available for use today.

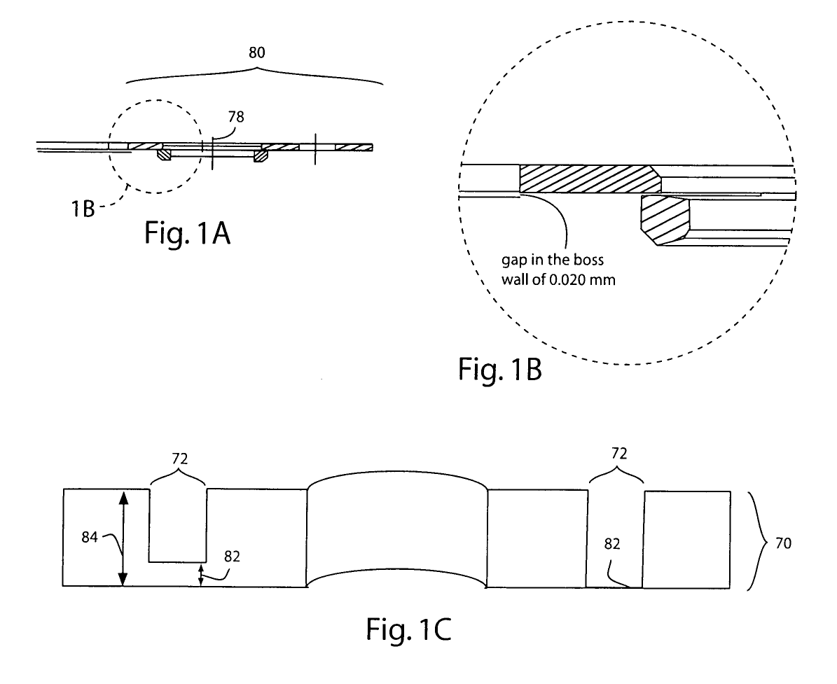

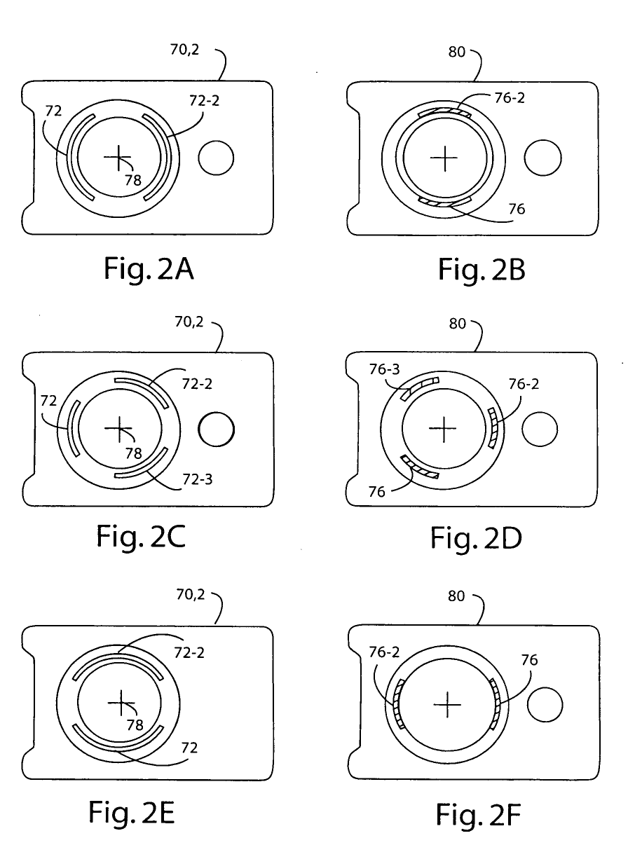

The base plate blank 70 may further include at least three of the radial troughs 72, as shown in FIG. 2C. Each of the radial troughs may subtend angle of at least thirty degrees about the swage center 78. The thickness 82 of each of the radial troughs is less than the thickness of the blank 84, which is essentially the same as the thickness of the base plate blank 84 as shown in Figure 1C. The thickness of each of the radial troughs may preferably be zero millimeters.

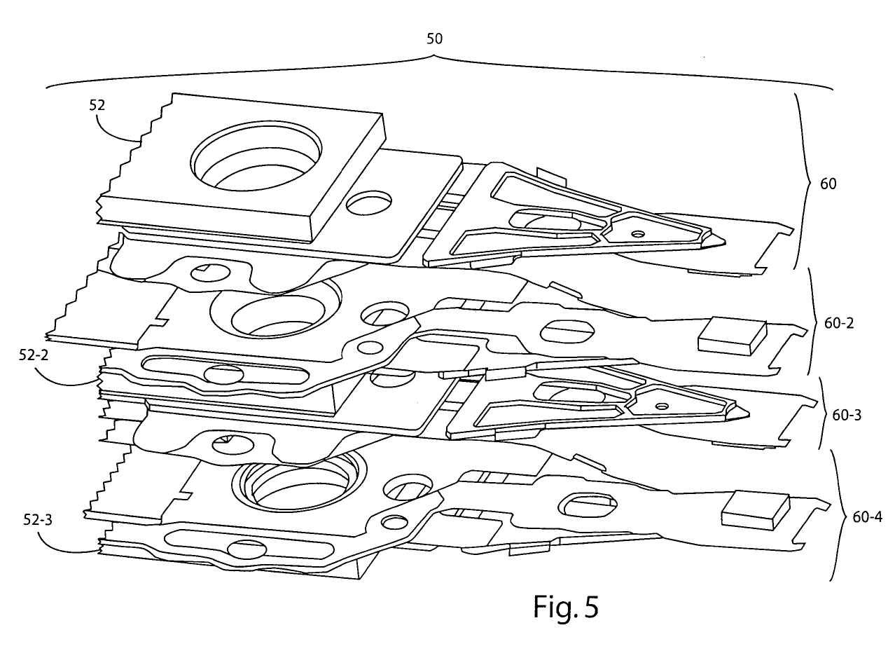

The base plate blank 70 is used to make a base plate 80 for a head gimbal assembly 60 by die-stamping the base plate blank. For at least one of the radial troughs 72, the process forms a contact zone 76 away from the radial trough, as shown in FIGS. 2B, 2D, and 2F. FIGS. 3A and 3B provide a perspective and cross section views of the base plate of FIG. 2F. The die-stamping further includes forming a contact zone away from the radial trough, for each of the radial troughs. The base plate is a product of this manufacturing process.

In experiments performed using a very expensive manufacturing process for the base plate blank 70, known as wire EDM, the resulting base plate 80 showed several improvements in tests using the base plate swaged to an actuator arm 52. Its flatness improved, as well as the gram change and torque retention. However, the wire EDM manufacturing method is far too expensive for use on this part in a contemporary hard disk drive 10. Figures 1A and 1B show the gap left after swaging, which keeps the base plate from buckling.

The definition of gram change used herein includes the change in a measured HGA normal load force due to a swaging assembly process. The definition of torque retention used herein includes the torque required to move a suspension relative to an actuator arm after the suspension has been swaged into the actuator arm.

The invention includes the head suspension assembly including the base plate, a head gimbal assembly including the head suspension assembly, an actuator assembly including at least one head gimbal assembly, and a hard disk drive including the actuator assembly. The invention also includes the methods of making these elements of the invention. The invention also includes these elements as products of the manufacturing methods.

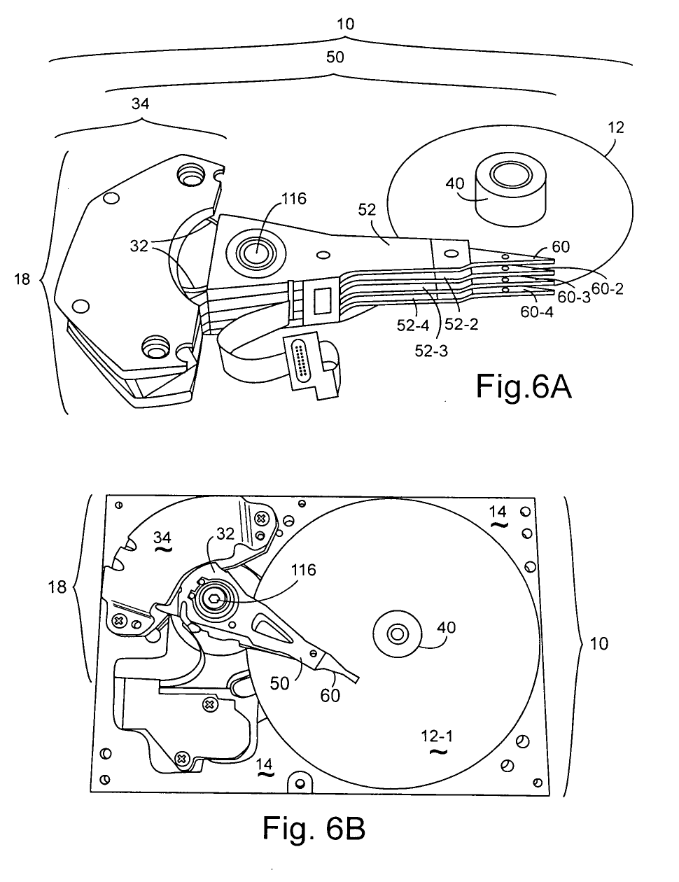

The head suspension assembly 62 of FIG. 4 includes the load beam 30, a hinge 70 and the base plate 80 in accordance with the invention. The making of the head suspension assembly includes attaching the load beam to the hinge. The hinge is attached to the base plate.

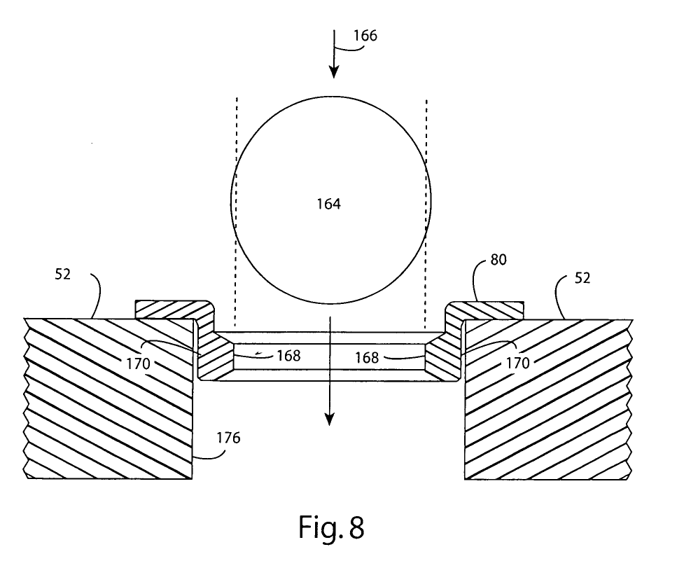

A head gimbal assembly 60 further includes the head suspension assembly 62, a slider 90, connected electrically and mechanically to a flexure finger 20. The flexure finger is attached to at least the load beam 30. The slider includes the read-write head 100, which is embedded in it, forming an air-bearing surface for flying a few nano-meters off the disk surface 12-1 during normal access operations of the hard disk drive 10 as shown in FIG. 6B.

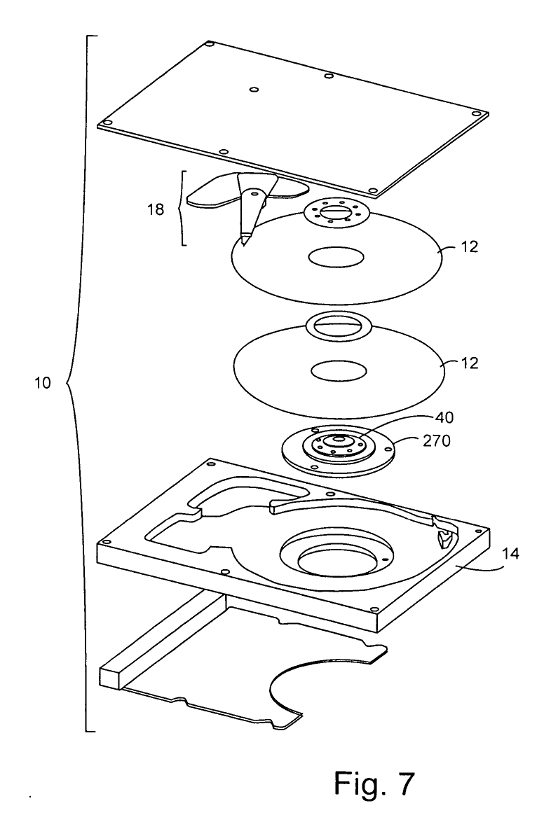

Each actuator arm 52 attaches to at least one head gimbal assembly 60, as shown in FIG. 5. In certain preferred embodiments of the invention, the base plate 80 of the head gimbal assembly provides the top layer coupling the actuator arm 52 to the head gimbal assembly.

The actuator assembly 50 includes at least one actuator arm 52, and as shown, may include additional actuator arms 52-2 and 52-3. The actuator arm 52 may couple with more than one head gimbal assembly 60. By way of example, the second actuator arm 52-2 may preferably include the second head gimbal assembly 60-2 and the third head gimbal assembly 60-3. Such an actuator arm may be preferred to minimize manufacturing expense. The second actuator arm preferably accesses two rotating disk surfaces (which are not shown) and may further improve the overall reliability of the hard disk drive 10.

The head gimbal assembly 60 may further include a micro-actuator assembly, coupling the slider, the flexure, and the load beam, as well as providing electrical coupling to the read-write head. Since the micro-actuator assembly is not typically involved with coupling the head gimbal assembly to the actuator arm, it is not shown in these Figures.

FIGS. 6A and 6B show a partially assembled hard disk drive 10 including the head gimbal assembly 60 coupled with an actuator arm 52, included in a voice coil motor 18. The voice coil motor includes an actuator assembly 50, which includes the head gimbal assembly 60.

A disk surface 12-1 is shown rotating about spindle 40 to create the rotating disk surface. The actuator assembly 50 pivots about the actuator pivot 116. The actuator assembly includes the actuator arm 52 coupled with the voice coil 32. When the voice coil is electrically stimulated with a time-varying electrical signal, it inductively interacts with a fixed magnet 34 attached to the voice coil yoke, causing the actuator arm to pivot by lever action through the actuator pivot. Typically, the fixed magnet is composed of two parts, one attached to the voice coil yoke and the other attached to the bottom voice coil yoke. As the actuator arm pivots, the head gimbal assembly 60 is moved across the disk surface 12-1. This provides the coarse positioning of the slider 90, and consequently, the read-write head 100 over a specific track.

FIG. 7 shows an exploded view of the primary components of the hard disk drive 10 including the voice coil motor 18. The hard disk drive further includes a disk base 14 to which the actuator assembly 50 is preferably mounted. The spindle motor 270 preferably drives the disk 12, and consequently the disk surface 12-1 through the spindle 40. The hard disk drive may further include a second rotating disk surface, to which a second actuator arm 52-2 may position a second head gimbal assembly 60-2. An embedded printed circuit board is used to control the positioning of the read-write head 100, possibly by also using a micro-actuator assembly, as well as the coarse positioning through the interactions with the voice coil 32, the fixed magnet 34 and the actuator arm 52 of the actuator assembly 50.

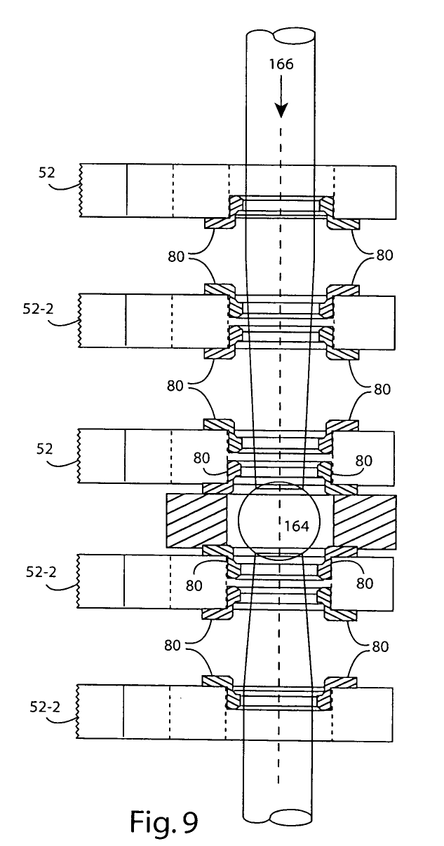

The swaging process for attachment of the head gimbal assemblies to the actuator arms is shown and described in connection with FIGS. 8 and 9. FIG. 8 shows a side view of the swage channel 166 at the end of the actuator arms 52 in an actuator assembly 50. A swage ball 164 is being swaged through a single base plate on a single actuator arm 52, and FIG. 9 shows the swaging process coupling multiple actuator arms with head gimbal assemblies for an actuator assembly 50.

The base plate 80 includes a cylindrical boss 162 having an inner face 168 and an outer periphery 170. The outer periphery 170 is inserted into a through-hole 176 in the actuator arm 52. The process of swaging includes the pressing and fastening of the periphery 170 of the cylindrical boss 162 to the inner face of the through-hole 176 in the actuator arm 52.

FIG. 9 shows the process repeated for an actuator assembly 50 including multiple actuator arms. Here, head gimbal assemblies are placed one by one into a comb assembly and are held against an actuator arm 52 with retaining fingers until all “bottom” head gimbal assemblies are in place. Tightly fitting spacers are inserted between base plates on the head suspension assemblies. The comb arms and spacers are then clamped between a movable clamp and anvil. The swage ball 164 is then driven through each base plate 80 using a swaging rod through swage channel 166 to expand the peripheral boss 170 into the arm holes. Then the process is repeated to accomplish the attachment of all the “top” head gimbal assemblies. It is understood that the “top” and “bottom” processes may easily be reversed.

The preceding embodiments provide examples of the invention and are not meant to constrain the scope of the following claims.

What is claimed is:

1. A method of making a base plate blank, comprising at least one of the steps:
photo-etching a blank to create said base plate blank; and
laser-cutting said blank to create said base plate blank;
wherein said base plate blank, comprises: at least two radial troughs symmetrically arranged about a swage center.

2. The base plate blank as a product of the process of claim 1.

3. The base plate blank of claim 2, further comprising at least three of said radial troughs symmetrically arranged about said swage center.

4. The base plate blank of claim 2, wherein each of said radial troughs subtends an angle of at least thirty degrees about said swage center.

5. The base plate blank of claim 2, wherein the thickness of each of said radial troughs is less than the thickness of said blank.

6. The base plate blank of claim 5, wherein said thickness of each of said radial troughs is zero millimeters.

7. A method using said base plate blank of claim 2 to create a base plate for a head gimbal assembly, comprising the step of:
die-stamping said base plate blank to create said base plate, further comprising, for at least one of said radial troughs, the steps:
forming a contact zone radially away from said radial trough.

8. The method of claim 7, wherein the step die-stamping, further comprises, for each of said radial troughs, the steps:
forming said contact zone radially away from said radial trough.

9. The base plate, as a product of the process of claim 7.

10. A head suspension assembly, comprising: said base plate of claim 9 coupling through a hinge to a load beam.

11. A head gimbal assembly, comprising:
said head suspension assembly of claim 9;
a slider coupling to a flexure circuit; and further comprising:
said flexure coupling to said load beam.

12. A head stack assembly, comprising: said head gimbal assembly of claim 11 coupled through said base plate with an actuator arm.

13. The head stack assembly of claim 12, further comprising a second of said head gimbal assemblies coupled through a second of said base plates with said actuator arm.

14. An actuator assembly, comprising said head stack assembly of claim 12 coupled through said actuator arm to a voice coil.

15. A hard disk drive, comprising: a fixed magnet fixedly mounted to a disk base and said actuator assembly of claim 14 pivotably mounted by an actuator pivot to said disk base with said voice coil movably positioned near said fixed magnet.

16. A method of making a head suspension assembly, comprising the steps:
coupling said base plate of claim 9 through a hinge to a load beam to create said head suspension assembly.

17. The head suspension assembly as a product of the process of claim 16.

18. A method of making a head gimbal assembly, comprising the steps:
coupling a flexure to said load beam included in said head suspension assembly of claim 17; and
coupling a slider to said flexure.

19. The head gimbal assembly, as product of the process of claim 18.

20. A method of making a head stack assembly, comprising the step:
coupling said head gimbal assembly of claim 19 through swaging said base plate with said actuator arm.

21. The head stack assembly, as a product of the process of claim 20.

22. A method of making an actuator assembly, comprising the step: coupling said head stack assembly of claim 21 through said actuator arm to said voice coil to create said actuator assembly.

23. The actuator assembly, as a product of the process of claim 22.

24. A method of making a hard disk drive, comprising the step: pivotably mounting said actuator assembly of claim 23 by an actuator pivot to a disk base with a voice coil movably positioned near a fixed magnet fixedly mounted to said disk base to create said hard disk drive.

25. The hard disk drive as a product of the process of claim 24.
